(19) United States
(12) Patent Application Publication
(10) Pub. No.: US 2010/0215971 A1
(43) Pub. Date: Aug. 26, 2010

(54) METHOD FOR METALLIZING POLYESTER AND METALLIZED POLYESTER

(75) Inventors: Detlef Militz, Hoppegarten (DE); Dieter Kreysig, Berlin (DE)

Correspondence Address: OUIMET LAW OFFICES, 1800 9TH AVENUE, # 1630, SEATTLE, WA, 98101, US

(73) Assignee: Detlef MILITZ, Hoppegarten (DE)

(21) Appl. No.: 12/515,678

(22) PCT Filed: Nov. 21, 2007
(86) PCT No.: PCT/EP2007/062644

§ 371 Date: Sep. 18, 2009

(30) Foreign Application Priority Data
Nov. 21, 2006 (DE) 10 2006 055 763.8

(51) Int. Cl. B32B 27/06; C08L 67/00; B32B 15/04

(52) U.S. Cl. 428/450; 525/418; 428/457

(57) ABSTRACT

The present invention relates to a method for metallizing polyester, wherein the polyester
is treated with an alkaline solution,
is treated with at least one compound having at least one functional group selected from the group consisting of a primary amine, a secondary amine, a thiol, a sulphide, and an olefin, and the compound is cross-linked,
the treated polyester is treated with a solution containing at least one metal salt selected from the group consisting of a silver salt, a copper salt, and a nickel salt, and at least one complexing agent, and
is treated with at least one reducing agent.
   Also, the present invention relates to polyesters metallized according to this method as well as the use thereof for antimicrobially treating liquid in liquid-guiding systems or for producing socks, insoles, clothing, covering textiles for seating furniture or mattresses. Furthermore, the present invention relates to a coated polyester containing a polyester having a layer of a cross-linked product of a compound having at least one functional group selected from the group consisting of a primary amine, a secondary amine, a thiol, a sulphide, and an olefin, and a layer of at least one metal selected from the group consisting of silver, copper, and nickel.

The present invention relates to a method for metallizing polyester. Furthermore, the present invention relates to polyester produced according to a method for metallization as well as the use thereof. Furthermore, the present invention relates to polyester coated with a metal.

Methods for metallizing polyester as well as metallized polyester are known in the prior art.

For instance, U.S. Pat. No. 4,681,591 describes a method for producing a metallized polyester fibre textile material comprising the steps of: pre-treating the textile material comprising at least 15% by weight of polyester fibres and any type of different fibres which can be selected from cotton, nylon 6, nylon 66, acrylic fibres, and glass fibres, with an aqueous solution of a caustic alkali, activation-treating the pre-treated textile material with a tin (II)-containing compound and with a palladium-containing compound and non-electrolytically plating the activation-treated textile material in a mixture containing nickel, copper, cobalt, chromium, or alloys thereof to form a metal coating thereon. A textile material produced in such a way is suitable as electromagnetic radiation-shielding.

A method for pre-treating polyester which has to be subsequently plated with a metal is described in EP 0 156 120 A2. In this method, a polyester material is treated with a composition containing a solvent system. The solvent system comprises water, at least one water-soluble organic solvent, and an effective amount of solvatized hydroxide ions. Subsequently, the so-treated polyester material can be plated with a metal and, for example, employed as radiation-shielding, for producing circuits or for enhancing the conductance of plastics.

DE 34 19 755 A1 discloses a method for silver plating non-metallic materials. While doing so, a surface to be silver plated is activated with at least one compound on basis of palladium and is subsequently silver plated by the use of a silver plating bath. Additionally to a silver salt, the silver plating bath contains thiocyanate ions as complexing agent and hydroxylamine as reducing agent.

JP 2005105386 A describes a bath for silver plating fibres. The bath contains a silver salt, a complexing agent, a stabilizing agent, and a reducing agent.

A method for metallizing polyester is disclosed in JP 61281874, wherein polyester is treated with caustic soda, sensibilized, activated and subsequently metallized with nickel or copper.

A method for producing metallized substrates is described in JP 2001295058, wherein a glass or a ceramics as substrate is subjected to a surface treatment with a silane coupling agent having at least one functional group and subsequently a dispersion of metallic particles. After cleaning, the substrate is plated with a metal layer.

Further, nanosol-coatings into which can be embedded and released in controlled manner silver or silver compounds are known from the article having the title “Biocidal Coatings based on Silica Nanosols” by B. Mahltig et al. (VDI-Berichte (2003), Nanofair 2003: New Ideas for Industry, p. 291-294). These coatings are inorganic materials, especially materials on basis of silica gel.

A method for modifying polymer surfaces for metal deposition is disclosed in WO 2006/052548 A1, wherein a polymer is modified by an etching agent, the modified polymer is silylated to provide a polymer having amino groups, and a noble metal is deposited on the polymer containing amino groups.

DE 600 02 681 T2 describes a method for producing a carrier material having biocidal properties, wherein chitosan is deposited on the carrier material, the carrier material is immersed in a solution of silver salt, the silver salt is reduced, the chitosan is cross-linked, and the carrier material is washed.

A method for metallizing fibrous material is described in DE 689 14 485 T2, wherein the fibrous material is coated with polymers which can be functionalized. Subsequently, a metallizing is carried out.

A problem of the metallized polyesters described in the prior art is that metal and/or metal ions dissolve away from the metal layer, especially, if employed into liquid-guiding systems, resulting in an uncontrolled release and a fast abrasion of the metallized polyester. Especially, in regard to environmental and waste disposal considerations and also to the profitability of such materials, an uncontrolled release of metal or metal ions is disadvantageous, respectively.

Especially, the uncontrolled and often too elevated release of metal or metal ions, respectively, into a liquid prevents the use of metallized polyester in liquid-guiding systems, because such polyesters do not meet the system guidelines or directives and regulations which have been issued, for example, for protection of the environment or the consumer by the EU such as the EU directive 98/83 for drinking water.

It is an object of the present invention to provide an improved method for producing metallized polyester providing a good adhesion between metal and polyester.

The object is solved by a method for metallizing polyester, wherein the polyester
is treated with an alkaline solution,
is treated with at least one compound having at least one functional group selected from the group consisting of a primary amine, a secondary amine, a thiol, a sulphide, and an olefin, and the compound is cross-linked,
the treated polyester is treated with a solution containing at least one metal salt selected from the group consisting of a silver salt, a copper salt, and a nickel salt, and at least one complexing agent, and
is treated with at least one reducing agent.

Treating the polyester with an alkaline solution serves to the purpose of the surface activation, wherein a micro roughness is generated at the surface layers of the polyester. Treating the polyester with a compound having a functional group, i.e., nitrogen containing group, sulphur containing group or olefin group, provides it with a functionalized layer. Cross-linking the compound can be realized by self-cross-linking of the compound such as by condensation. Alternatively, cross-linking the compound can be realized by addition of at least one further compound and cross-linking with it such as by an addition. By treatment with a solution containing a metal salt and a complexing agent, metal is fixated by interactions, especially by coordinative or ionic interactions, respectively, to the functional groups. Subsequently, the ionic metal is reduced to form a metal layer. Polyester plated with metal having a low metal releasability can be obtained by the method according to the invention. I.e., the metal adheres to the polyester obtained in an excellent manner.

Also, the metallized polyester obtained by the method and the use thereof are objects of the present invention. The metallized polyester is used for antimicrobially treating liquid in liquid-guiding systems or for producing socks, insoles, clothing, covering textiles for seating furniture or mattresses. Especially, on one hand due to the achieved excellent adhesion of the silver to the polyester obtained according to the invention and a reduced release of silver into the environment achieved in this manner and on the other hand due to the biocidal effect of the silver, the above uses are advantageous for the silver plated polyester obtained according to the invention.

It is a further object of the present invention to provide a coated polyester having a well adhering metal layer.

According to the invention, this object is solved by providing a coated polyester comprising a polyester having a layer of a cross-linked product obtained by a condensation or addition reaction of at least one compound having at least one functional group selected from the group consisting of a primary amine, a secondary amine, a thiol, a sulphide, and an olefin, and a layer of at least one metal selected from the group consisting of silver, copper, and nickel. The metal layer adheres to the polymer by means of the layer of the cross-linked product in an excellent manner.

Further advantageous embodiments of the present invention are described in the dependent claims.

In an advantageous embodiment of the present invention, the alkaline solution is an aqueous and/or alcoholic solution containing at least one base. Preferably, the base is sodium hydroxide. A further preferred base is potassium hydroxide. The aqueous solution is water. Advantageously, the alcoholic solution is methanol, ethanol or propanol or mixtures thereof. Preferably, ethanol is used as an alcoholic solution. The alcoholic solution is well miscible with water, according to the invention, there are also used mixtures of aqueous solution and alcoholic solution. The mixing ratio of aqueous solution to alcoholic solution is in the range from 1:50 up to 50:1, preferably from 1:10 up to 10:1, more preferably from 1:5 up to 5:1, aqueous solution:alcoholic solution (v/v). Most preferably, an aqueous solution is employed. The amount of the base contained in the aqueous and/or alcoholic solution is selected in such a manner that a 0,5N to 3N alkaline solution is employed. Preferably, the alkaline solution is an aqueous NaOH solution. Alternatively, the alkaline solution can also be a solution on basis of amine such as an ammonia solution.

The polyester is treated with the alkaline solution at temperatures from 0° C. to 145° C., preferably 50° C. to 130° C., more preferably from 70° C. to 115° C., either depressurized or at pressures from 1 to 10 bar. Advantageously, the treatment time is between 5 minutes and 2 hours, particularly advantageously between 10 minutes and 30 minutes, more advantageously about 15 minutes. Treating the polyester with the alkaline solution comprises an immersion and/or placement of the polyester into the alkaline solution. Alternatively, the polyester is sprayed with the alkaline solution. Further, the polyester is alternatively wetted with the alkaline solution.

In an advantageous embodiment, the polyester is washed with water and dried subsequent to the treatment with the alkaline solution. Washing with water is performed by repeated immersion into water. Drying is conducted by heating the polyester by means of a drying system such as a drying oven. The drying oven is heated up to 140° C., preferably up to 120° C. Alternatively, drying is conducted by allowing the polyester to stand at room temperature.

In an advantageous embodiment, the at least one compound selected from the group consisting of a primary amine, a secondary amine, a thiol, a sulphide, and an olefin, is a compound of the Formula

(R¹O)ₓ(MR₄₋ₓ (I),

wherein
R¹ is a branched or straight-chain alkyl having 1 to 20 carbon atoms, preferably 1 to 10 carbon atoms, more preferably having 1 to 8 carbon atoms, even more preferably having 1 or 2 carbon atoms,
x is a number from 1 to 3, preferably 3,

### M is Si, Ti or Sn, and

R is selected from the group consisting of CH₂CH₂CH₂NH₂, CH₂CH₂CH₂SH, CH═CH₂, (CH₂)ₚNH(CH₂)ₙNH(CH₂)ₗNH₂, and (CH₂)ₙNHₘ[(CH₂)ₗNH₂]ₖ,
p is an integer from 1 to 7, preferably 2 or 3,
n is an integer from 1 to 7, preferably 2 or 3,
m is zero, if k is 2,
m is 1, if k is 1,
and l is an integer from 1 to 7, preferably 2 or 3.

Such a compound is able to embed into the micro roughnesses of the pre-treated polyester. Further, a compound can be cross-linked by a subsequent condensation step and, therefore, act as protection layer for the polyester. Especially, in the presence of water, the alkoxy groups of the compound of the Formula (I) hydrolyze to become silanol groups. By condensation of these silanol groups, a siloxane network can be formed. The hydrolysis rate is dependent on the one hand on the environmental conditions, particularly on the pH value and the temperature, on the other hand on the kind of the silane. Preferably, a hydrolysis in an acidic aqueous-alcoholic solution is carried out. Preferably, the condensation is carried out by exposing the treated polyester to a temperature in the range from 120° C. to 200° C., preferably 140° C. and 170° C., more preferably 140° C. and 150° C. For example, if M is Si, a polysilicic acid can be formed by condensation of at least one compound according to Formula (I). Thus, in an advantageous embodiment, M is Si. By treating the pre-treated polyester with a compound of the above Formula (I), the polyester is provided with a functionalizable layer.

Advantageously, the treatment with at least one compound of the Formula (I) comprises padding the polyester treated with the alkaline solution. For carrying out the padding, the compound of the Formula (I) is advantageously solved in water and/or an alcohol being advantageously mixed with hydrochloric acid, respectively. The alcohol is methanol, ethanol, propanol and/or butanol. Alternatively, the compound of the Formula (I) is used for padding in pure form. Subsequently, the treated polyester is dried. Drying results to a more uniform coating on the polyester. By drying at elevated temperature, a condensation of the compound of the Formula (I) is accelerated, wherein the elevated temperature is between 120° C. and 200° C.

In a further advantageous embodiment of the present invention, the treatment with at least one compound selected from the group consisting of a primary amine, a secondary amine, a thiol, a sulphide, and an olefin, and the cross-linking of the compound comprises
contacting the polyester treated with an alkaline solution with at least one compound of the Formula (I),

(R¹O)ₓMR₄₋ₓ (I)

wherein
each R and R1 is independently from each other a branched or straight-chain alkyl having 1 to 20 carbon atoms, preferably having 1 to 10 carbon atoms, more preferably having 1 to 8 carbon atoms, even more preferably having 1 or 2 carbon atoms,
x is 1 to 4, and

### M is Si, Ti or Sn,

optionally a first condensation,
contacting with at least one compound of the Formula (I),
   wherein
   R¹ is a branched or straight-chain alkyl having 1 to 20 carbon atoms, preferably having 1 to 10 carbon atoms, more preferably having 1 to 8 carbon atoms, even more preferably having 1 or 2 carbon atoms,
   x is 1 to 3, preferably 3,

### M is Si, Ti or Sn, and

R is selected from the group consisting of CH₂CH₂CH₂NH₂, CH₂CH₂CH₂SH, CH═CH₂, (CH₂)ₚNH(CH₂)ₙNH(CH₂)ₗNH₂, and (CH₂)ₙNHₘ[(CH₂)ₗNH₂]ₖ,
p is an integer from 1 to 7, preferably 2 or 3,
n is an integer from 1 to 7, preferably 2 or 3,
m is zero, if k is 2,
m is 1, if k is 1,
and l is an integer from 1 to 7, preferably 2 or 3, and
a second condensation.

In the following, a compound of the Formula (I), wherein each R and R1 is independently from each other a branched or straight-chain alkyl having 1 to 20 carbon atoms, preferably having 1 to 10 carbon atoms, more preferably 1 to 8 carbon atoms, even more preferably having 1 or 2 carbon atoms, x is 1 to 4, and M is Si, Ti or Sn, is referred to an unfunctionalized alkoxy compound. Advantageous unfunctionalized alkoxy compounds used according to the invention are tetrabutoxysilane (tetrabutylorthosilicate), tetrapropoxysilane (tetrapropylorthosilicate), tetraethoxysilane (tetraethylorthosilicate), tetramethoxysilane (tetrannethylorthosilicate), triethoxyoctylsilane, trimethoxyoctylsilane, triethoxyethylsilane, trimethoxyethylsilane, triethoxymethylsilane, trimethoxymethylsilane, isooctyltrimethoxysilane, and isooctyltriethoxysilane, wherein tetraethoxysilane, tetramethoxysilane, triethoxyoctylsilane, and triethoxynnethylsilane are particularly preferred.

In the following, a compound of the Formula (I),

wherein
R¹ is a branched or straight-chain alkyl having 1 to 20 carbon atoms, preferably having 1 to 10 carbon atoms, more preferably having 1 to 8 carbon atoms, even more preferably having 1 or 2 carbon atoms,
x is 1 to 3, preferably 3,

### M is Si, Ti or Sn, and

R is selected from the group consisting of CH₂CH₂CH₂NH₂, CH₂CH₂CH₂SH, CH═CH₂, (CH₂)ₚNH(CH₂)ₙNH(CH₂)ₗNH₂, and (CH₂)ₙNHₘ[(CH₂)ₗNH₂]ₖ,
p is an integer from 1 to 7, preferably 2 or 3,
n is an integer from 1 to 7, preferably 2 or 3,
m is zero, if k is 2,
m is 1, if k is 1, and
l is an integer from 1 to 7, preferably 2 or 3, is referred to a functionalized alkoxy compound.

Examples for functionalized alkoxy compounds used advantageously are especially, but are not limited to 3-aminopropyltripropoxysilane, 3-aminopropyltriethoxysilane, 3-aminopropyltrimethoxysilane, 3-mercaptopropyltributoxysilane (3-tributoxysilyl-1-propanethiol), 3-mercaptopropyltripropoxysilane (3-tripropoxysilyl-1-propanethiol), 3-mercaptopropyltriethoxysilane (3-triethoxysilyl-1-propanethiol), 3-mercaptopropyltrimethoxysilane (3-trimethoxysilyl-1-propanethiol), triethoxyvinylsilane, trimethoxyvinylsilane, divinyldiethoxysilane, trivinylmethoxysilane and tri-(3-aminopropyl)ethoxysilane, N-(2-aminoethyl)-3-aminopropyltrimethoxysilane, 2-[2-(3-trimethoxysilylpropylamino)ethylamine]ethylamine. Particularly advantageously, 3-aminopropyltriethoxysilane and 3-aminopropyltrimethoxysilane, 3-mercaptopropyltrimethoxysilane (3-trimethoxysilyl-1-propanethiol), triethoxyvinylsilane, N-(2-aminoethyl)-3-aminopropyltrimethoxysilane, 2-[2-(3-trimethoxysilylpropylamino)ethylamine]ethylamine are employed into the method according to the invention.

In dependence on the desired properties of the cross-linked layer created on the polyester, a first condensation is optionally carried out subsequent to the treatment of the polyester with the unfunctionalized alkoxy compound.

In a first embodiment variation, a first condensation is carried out subsequent to the treatment of the polyester with an unfunctionalized alkoxy compound and before the treatment with a functionalized alkoxy compound. Thereby, a base coat layer on basis of a cross-linked unfunctionalized alkoxy compound is created on the polyester. The base coat layer serves to prevent a possible reaction of the functionalized alkoxy compound with the treated polyester which could lead to disintegration of the polyester structure.

In a second embodiment variation, a first condensation is not carried out subsequent to the treatment of the polyester with an unfunctionalized alkoxy compound and before the treatment with a functionalized alkoxy compound. On the contrary, the polyester treated with the alkaline solution is treated with an unfunctionalized alkoxy compound and with a functionalized alkoxy compound, and subsequently a condensation is carried out in such a manner that both the unfunctionalized and the functionalized alkoxy compound of the Formula (I) condensate with theirselves and with each other, respectively. The treatment with the unfunctionalized alkoxy compound and the functionalized alkoxy compound can be performed in sequence. Alternatively, the polyester is treated with a mixture of the unfunctionalized alkoxy compound and functionalized alkoxy compound. The admixture of the unfunctionalized alkoxy compound to the functionalized alkoxy compound fulfills several purposes. By doing this, the hydrophobicity/hydrophility of the generated layer created by the subsequent condensation is controllable by the amount of unfunctionalized alkoxy compound in relation to the amount of the functionalized alkoxy compound. Furthermore, the proportion of functional groups in this layer is controllable in this way. Additionally, as a rule, the unfunctionalized alkoxy compounds of the Formula (I) are more inexpensive in relation to the functionalized alkoxy compounds in such a manner that their use reduces the costs.

Contacting the treated polyester with at least one unfunctionalized alkoxy compound of the Formula (I) and with at least one functionalized alkoxy compound of the Formula (I) comprises in dependence on the above embodiment variation a first and, if necessary, a second padding of the polyester. In the above first embodiment variation, i.e. performance of a first and second condensation, a first padding subsequent to the treatment of the polyester with the unfunctionalized alkoxy compound and a second padding subsequent to the treatment of the polyester with the functionalized alkoxy compound are carried out. In the above second embodiment variation, a padding is carried out subsequent to the treatment of the polyester with the unfunctionalized alkoxy compound and the functionalized alkoxy compound. During the first or second padding, the unfunctionalized or functionalized alkoxy compound is dispersed in a solvent and applied on the polyester and used by padding, respectively. The solvent is water, methanol, ethanol, propanol and/or butanol, preferably mixed with hydrochloric acid. Subsequent to the first or second padding, a first or second condensation is carried out, respectively. The first or second condensation is carried out by heating the polyester treated with at least one compound of the Formula (I) up to 200° C., preferably up to 170° C., more preferably up to 140° C., respectively. The condensation time is set in dependence on the temperature and is up to 15 minutes, preferably up to 5 minutes, more preferably up to 1 minute. In an advantageous embodiment, the polyester treated in that way is washed by repeated immersion in water and subsequently dried subsequent to the first and second condensation, respectively.

Alternatively, the at least one compound having at least one functional group selected from the group consisting of a primary amine, a secondary amine, a thiol, a sulphide, and an olefin is a liquid polyfunctional amine. In this case, the steps of the treatment of the polyester with an alkaline solution and the treatment of the polyester with at least one compound having at least one functional group selected from the group consisting of a primary amine, a secondary amine, a thiol, a sulphide, or an olefin occur simultaneously, since a liquid polyfunctional amine is both an alkaline solution and a compound having at least one functional group selected from the group consisting of a primary amine, a secondary amine, a thiol, a sulphide, or an olefin.

Especially, the liquid polyfunctional amine is a compound of the Formula

R²NHR³ (II),

wherein R² is selected from the group consisting of H₂N(CH₂)_{w}, R⁴₃Si(CH₂)_{w}, and H₂NC₆H₄,
R³ is selected from the group consisting of [(CH₂)ₓNH]_{y}(CH₂)_{z}NH₂, R₃Si(CH₂)_{y}, and H₂NC₆H₄NH(CH₂)_{y},
w is an integer from 1 to 7, preferably 2 or 3,
x is an integer from 1 to 7, preferably 2 or 3,
y is zero or an integer from 1 to 7, preferably zero, 1 or 2,
z is an integer from 1 to 7, preferably 2 or 3, and
R⁴ is a branched or straight-chain alkyl or —O-alkyl having 1 to 10 carbon atoms, preferably having 1 to 8 carbon atoms, more preferably having 1 or 2 carbon atoms. Due to the multiple functionality, such a compound is able to undergo a cross-linking reaction in case of an addition of a further suitable compound in an easy manner.

If R² is H₂N(CH₂)_{w}, in an advantageous embodiment, R³ is [(CH₂)ₓNH]_{y}(CH₂)_{z}NH₂, wherein w, x, y and z are defined as above. If R² is R⁴₃Si(CH₂)_{w}, in an advantageous embodiment, R³ is R⁴₃Si(CH₂)_{y}, wherein R⁴, w and y are defined as above, i.e. a compound of the Formula (II) has silane or silanol functions, respectively.

Advantageously, the compound of the Formula (II) is selected from the group consisting of bis(3-aminopropyl)amine, N,N′-bis(2-aminoethyl)-1,3-propanediamine, triethylenetetramine, tetraethylenepentamine, bis[3-(trimethylsilyl)propyl]amine, and bis[3-(trimethoxysilyl)propyl]amine. Especially advantageously, the compound of the Formula (II) is bis(3-aminopropyl)amine or tetraethylenepentamine.

In an advantageous embodiment of the method according to the invention, cross-linking the compound of the Formula (II) is carried out by contacting it with a compound having at least one isocynanate group, preferably two isocyanate groups. A compound of the Formula (II) undergoes with a compound having at least one isocynanate group an addition reaction by formation of an urea.

Advantageously, the compound having at least one isocynanate group is a diisocyanate. Preferably, the diisocyanate is selected from the group consisting of hexamethylene diisocyanate, tolylene diisocyanate, isophorone diisocyanate, and 4,4′-methylene-bis(cyclohexyl isocyanate). Especially preferably, the diisocyanate is hexamethylene diisocyanate.

To perform a cross-linking of the compound of the Formula (II) with a compound having at least one isocynanate group, the polyester is coated with the compound of the Formula (II), if necessary, used for padding, and subsequently coated with compound having at least one isocynanate group and, if necessary, used for padding. Then, the so-treated polyester is preferably washed, preferably with water. Then, the polyester is optionally dried.

Alternatively, to perform a cross-linking of the compound of the Formula (II) with a compound having at least one isocynanate group, the polyester is coated with the compound having at least one isocynanate group, if necessary, used for padding, and subsequently coated with a compound of the Formula (II), and, if necessary, used for padding. Then, the so-treated polyester is preferably washed, preferably with water. Then, the polyester is optionally dried such as by allowing it to stand at room temperature.

Coating the polyester with a compound of the Formula (II) or a compound having at least one isocynanate group, respectively, is carried out by immersing, placing, spraying or wetting the polyester with the respective compound. Optionally, the adequate compound can be solved in a solvent, preferably water. The concentration of the respective compound employed ranges from 100% to 0.1%.

In an advantageous embodiment, the complexing agent employed into the method according to the invention is selected from the group consisting of ammonia, ethylenediamine, triethanolamine, ethanolamine, 1,3-diaminopropane, sodium thiosulphate, thioisocyanate, glycerol, sodium tartrate, potassium sodium tartrate, and sodium citrate. Especially advantageously, the complexing agent is ammonia. Ammonia is easily volatile. Therefore, excessive ammonia can easily be removed.

In an advantageous embodiment of the present invention, the metal salt is selected from the group consisting of silver halide, silver sulphate, silver nitrate, copper halide, copper sulphate, copper nitrate, copper acetate, nickel halide, nickel sulphate, nickel nitrate, and nickel acetate. Especially advantageously, the metal salt used is silver nitrate, silver chloride, or silver sulphate. More preferably, the metal salt is silver nitrate. Especially, halide employed according to the invention comprises chloride, bromide, and iodide.

Advantageously, the solution containing the metal salt and the complexing agent is an aqueous solution. Especially advantageously, the above solution comprises water, the metal salt, and the complexing agent. Advantageously, the ratio of metal salt to complexing agent is in the range from 1:1 to 1:10, preferably 1:2 to 1:3 (v/v). Advantageously, the treatment of the polyester with the metal salt and complexing agent containing solution is carried out at a temperature between 10° C. and 60° C., more advantageously between 20° C. and 50° C., most advantageously at 25° C. The treatment time is between 5 minutes and 2 days, advantageously between 30 minutes and 4 hours, more advantageously between 1 and 2 hours. Advantageously, the treatment is carried out by immersing or placing the treated polyester into the solution, respectively. Optionally, the polyester is dried subsequent to the treatment with the metal salt and complexing agent containing solution. Advantageously, drying is carried out at a temperature between 30° C. and 60° C., more advantageously between 40° C. and 55° C. Advantageously, the drying time is between 10 minutes and 30 minutes.

By treating the polyester provided with functional groups with the solution containing the metal salt and the complexing agent, the metal is fixated by interactions, especially by coordinative (particularly in the case of —NH₂) or ionic (particularly in the case of —SH) interactions, respectively.

In a further advantageous embodiment of the present invention, the reducing agent is selected from the group consisting of glucose, ascorbic acid, sodium borohydride, sodium dithionite, sodium sulphite, sodium formate, formaldehyde, and sodium hydrophosphite. The reducing agent serves to reduce the ionic metal. Preferably, the reducing agent is glucose or ascorbic acid. Glucose or ascorbic acid, respectively, is a very environmentally friendly reducing agent, easy to handle, easily available and non-toxic. If the reducing agent is glucose or ascorbic acid, the reduction is preferably carried out in water, especially at temperatures between 10° C. and 60° C., preferably 20° C. and 30° C., for a period between 5 minutes and 2 hours, preferably between 15 minutes and 1 hour. Especially, if glucose is used, the reducing agent is preferably employed in the form of an aqueous solution having a concentration from 1,25 to 5 g/l and a pH value in the range from 7 to 12, preferably, 8 to 10,5. For example, the pH value of the reducing agent containing solution can be adjusted by means of addition of ammonia. If the reducing agent is sodium borohydride, the reduction is preferably carried out in ethanol, especially at temperatures between 10° C. and 50° C., preferably 20° C. and 30° C., for a period between 5 minutes and 2 hours, preferably between 15 minutes and 1 hour. Advantageously, for the treatment with the reducing agent, the polyester is immersed or placed and, if necessary, moved in the reducing agent containing solution, respectively. The treatment of the polyester is carried out at a liquor ratio (ratio of the mass (kg) of the substrate to the volume (1) of the reducing agent solution) from 1:10 to 1:100, preferably 1:50 to 1:100. In an advantageous embodiment, the obtained metallized polyester is washed with water and optionally heated up to 150° C. for drying subsequent to the treatment with the reducing agent containing solution.

Advantageously, the method according to the invention is performed with a polyester selected from the group consisting of poly(ethylene terephthalate), poly(butylene terephthalate), and mixtures thereof. However, the method according to the invention is not limited to polyesters of this type. Examples of further polyester which can be metallized by means of the method according to the invention are, but are not limited to poly(1,4-cyclohexane dimethylene terephthalate), poly(ethylene oxybenzoate) or poly(1,4-cyclohexylidene dimethylene terephthalate). A particularly preferred polyester is poly(ethylene terephthalate).

In an advantageous embodiment of the method according to the invention, the polyester is treated subsequent to the step of the treatment with a reducing agent with an agent selected from the group consisting of reducing agent, complexing agent, and polymer. The operating principles of the agent are the reduction of ionic metal amounts possibly remaining subsequent to the performance of the method in the area of the surface of the metallized polyester, the removal of ionic metal amounts from the metallized polyester by means of complexation or a sealing of the metallized polyester, respectively. These strategies of action serve to prevent an uncontrolled high metal or metal ion release from the metallized polyester to the environment, respectively. In the basic idea of the present invention, such a treatment of the metallized polyester serves to effect an appropriate metal release controlled according to the respective application field. As a result, there are achieved not only a higher profitability, lower cleaning or waste disposal costs and lower damage to the environment, but also a controlled sustained release during the application. A controlled sustained release during the application means that a metal release authorized according to the respective directives, system guidelines and regulations occurs in a constant manner for a long period. Thereby, a long active time and, as a result, a long utilizability of the metallised polyester is obtained.

The treatment of the metallised polyester with a reducing agent is especially advantageous. The above-mentioned reducing agents are employed as reducing agent. The treatment conditions are the same as already mentioned above. In the case of polyester silver plated according to the invention, a preferred reducing agent is glucose. The reducing effect of aqueous glucose solutions is dependent on a.o. the glucose concentration and the pH-dependent red ox potential being dependent on the pH value in a linear manner. The silver release of the silver plated polyester subsequent to the treatment with the reducing agent is lowered in a linear manner at elevating pH value of the reducing solution and at elevating oxidation potential. I.e., by treating the metallized polyester with the reducing agent, the metal or metal ion release, in this case the silver or silver ion release, respectively, of the metallized polyester in a surrounding liquid can be adjusted to a determined value.

In another preferred embodiment, the agent is a complexing agent. An above-mentioned complexing agent is employed as complexing agent. The metallized polyester is rinsed with the complexing agent which can be in aqueous solution. Subsequently, the treated polyester is washed with water, if necessary, and dried at a temperature up to 140° C., if necessary.

In another preferred embodiment, the agent is a polymer. Preferably, the polymer is selected from the group consisting of polyurethane, polyacrylate, and finishing agent for high quality.

Metallized polyester is obtained by the method according to the invention. Especially, silver plated, copper plated or nickel plated polyester is obtained by means of the method according to the invention. Especially preferably, silver plated polyester is obtained by means of the method according to according to the invention. According to the basic idea of the present invention, the metallized polyester is a fully or partially metallized polyester.

Advantageously, the metallized polyester obtained by the method according to the invention is formed as a yarn, a fibre, a filament, a woven fabric, a knitted fabric, a meshing, an interlaced yarn or a non-woven fabric. Advantageously, the metallized polyester obtained by the method according to the invention is a fibre. Especially, it is suitable for producing socks and clothing in that case. In another advantageous embodiment of the present invention, the obtained metallized polyester is an interlaced yarn, particularly a spacer interlaced yarn. Especially, the spacer interlaced yarn is suitable for antimicrobially treating liquid in liquid-guiding systems and insoles.

Advantageously, the metallized polyester obtained by means of the method according to the invention is used for antimicrobially treating liquid in liquid-guiding systems. Especially, a silver plated polyester is suitable for it, since silver is capable to effectively inhibit bacteria due to its excellent antimicrobial effect. Alternatively, the metallized polyester obtained by the method according to the invention is used for producing socks, insoles, clothing, covering textiles for seating furniture or mattresses.

Preferably, the coated polyester according to the invention comprises 3 layers, namely a polyester, onto which a layer of a cross-linked product of a compound having at least one functional group selected from the group consisting of a primary amine, a secondary amine, a thiol, a sulphide, and an olefin is arranged, onto which a layer of a metal selected from the group consisting of silver, copper, and nickel is arranged.

Advantageously, the cross-linked product comprises a polysilicic acid having at least one functional group selected from the group consisting of a primary amine, a secondary amine, a thiol, a sulphide, and an olefin.

Preferably, the coated polyester comprises polyester having a layer of a condensation product of at least one compound of the Formula (I)

(R¹O)ₓ(MR₄₋ₓ (I),

wherein R¹ is a branched or straight-chain alkyl having 1 to 20 carbon atoms, preferably having 1 to 10 carbon atoms, more preferably having 1 to 8 carbon atoms, even more preferably having 1 or 2 carbon atoms,
x is a number from 1 to 3, preferably 3,

### M is Si,

R is selected from the group consisting of CH₂CH₂CH₂NH₂, CH₂CH₂CH₂SH, CH═CH₂, (CH₂)ₚNH(CH₂)ₙNH(CH₂)ₗNH₂, and (CH₂)ₙNHₘ[(CH₂)ₗNH₂]ₖ,
p is an integer from 1 to 7, preferably 2 or 3,
n is an integer from 1 to 7, preferably 2 or 3,
m is zero, if k is 2,
m is 1, if k is 1,
and l is an integer from 1 to 7, preferably 2 or 3, and
a layer of silver.

In another advantageous embodiment, the cross-linked product comprises urea.

Preferably, the urea is an addition product of at least one compound of the Formula

R²NHR³ (II),

wherein R² is selected from the group consisting of H₂N(CH₂)_{w}, R⁴₃Si(CH₂)_{w}, and H₂NC₆NH₄,
R³ is selected from the group consisting of [(CH₂)ₓNH]_{y}(CH₂)_{z}NH₂, R⁴₃Si(CH₂)_{y}, and H₂NC₆H₄NH(CH₂)_{y},
w is an integer from 1 to 7, preferably 2 or 3,
x is an integer from 1 to 7, preferably 2 or 3,
y is zero or an integer from 1 to 7, preferably zero, 1 or 2,
z is an integer from 1 to 7, preferably 2 or 3, and
R⁴ is a branched or straight-chain alkyl or —O-alkyl having 1 to 10 carbon atoms, preferably having 1 to 8 carbon atoms, more preferably having 1 or 2 carbon atoms, and
a compound selected from the group consisting of hexamethylene diisocyanate, tolylene diisocyanate, isophorone diisocyanate, and 4,4′-methylene-bis(cyclohexyl isocyanate).

Polyester obtained by the use of the method according to the invention is suitable for antimicrobially treating liquids in a liquid-guiding system. Especially, a silver plated polyester is suitable for it, since due to its excellent antimicrobial effect, silver is capable to effectively inhibit especially bacteria, fungi and micro algae. Alternatively, the polyester obtained by the method according to the invention is used for producing socks, insoles, clothing, covering textiles for seating furniture or mattresses. Also, in this case, due to its particular powerful oligodynamic properties, silver plated polyester is especially suitable.

Especially, the polyester obtained by the use of the method according to the invention is employed for the treatment of a liquid in the form of a process liquid or in the form of drinking water. These liquids can be in systems being closed or open to the surrounding atmosphere, stagnating or circulating, in power stations, industrial or commercial plants or air conditioners. In each case, the metal elution of the textile according to the invention can individually be adjusted in such a manner that the use for treating liquid in the form of drinking water complies with distinct national directives in regard to the maximum authorized metal concentration in drinking water, for example.

The term “process liquid” serves to a generic term for a liquid which fulfils one or more functionalities such as cooling, lubricating, hydraulically switching, and controlling or is consumed as service or industrial liquid.

A preferred use is the antimicrobial treatment of a liquid in a liquid-guiding system comprising the treatment of a liquid cooling lubricant in the cooling lubricant circulation of a metal-processing plant. Such cooling lubricants are generally used in industrial and commercial plants processing metals by intervention on the substance such as turning, milling or drilling. The use is especially advantageous, if the cooling lubricant is employed as water-oil-emulsion in a cooling lubricant system. Thereby, the cooling lubricant remains microbiologically stable without the need of biocides which are usually hitherto, particularly on basis of formaldehyde. This leads to lower health stress of the operating staff and lower costs by higher service life. By means of the method according to the invention, the release of antimicrobially acting metal components can be adjusted to the requirements in an optimal manner.

A further preferred use is the antimicrobial treatment of a liquid in a liquid-guiding system comprising the treatment of a liquid circuit medium in a hydraulic circuit of an industrial plant. Also, in hydraulic circuits, biological masse growth can be a problem. Especially, this applies for circuits having regions through which material which is suitable as food for a lot of micro organisms comes regularly into the hydraulic medium. For example, this applies for plants contacting cellulose containing materials. Also, this applies for materials having natural fibres like cotton, linen, wool etc. Thus, the method is especially advantageously employable, where the industrial or commercial plant is created as paper producing and/or processing plant or as plant for producing and/or processing textiles. Also, as mentioned above, the adjustment of the elution of oligodynamically active metal ions tailored to requirements is given in this case.

A further preferred use is the antimicrobial treatment of a liquid in a liquid-guiding system in a washing apparatus for laundry comprising the treatment of remained laundry rinsing water. In this way, it is possible to store remained laundry rinsing water in a tank without the risk of making this water unsuitable due to microbial activity in the long term. Especially, this is true, for example, if substances being a good nutrimental basis for micro organisms are washed out, while rinsing the laundry. Especially, this is the case, when washing natural fibre textiles. Thus, in a particular advantage, the treated laundry rinsing water will be employed as washing water for a newly starting washing step of the washing apparatus. By the fact that, f. e., the rinsing water of the last rinsing procedure in washing machines is collected for the use as first washing water in a new washing step, a further reduction of the water consumption of washing machines can be realized in an easy manner. This effect can be adopted to further washing apparatus and washing processes for distinct laundries.

A further preferred use is the antimicrobial treatment of a liquid in a liquid-guiding system in a medical technical device comprising the treatment of sterile process water. In this case, there is a regular need to ensure high requirements in regard to an enduring sterility of the water and a piping system coming in contact therewith. This can be ensured in an easy and reliable manner by using a three-dimensional fibre system having oligodynamic activity.

Especially advantageously, the coated polyester has poly(ethylene terephthalate), onto which a layer of a condensation product is arranged, onto which a layer of silver is arranged, wherein the condensation product is obtained by condensation of tetraalkoxysilane, wherein alkyl is methyl or ethyl, and subsequent condensation of 3-aminopropyltriethoxysilane or triethoxyvinylsilane.

Now, the present invention is explained in more detail referring to examples. However, the present invention is not limited to the examples.

### EXAMPLE 1

A woven fabric made of polyester was treated with aqueous sodium hydroxide solution (2N) at 100° C. for 20 minutes. The loss of weight was about 8%. The so-treated polyester was used for padding with a liquor of ethanol, conc. hydrochloric acid and tetramethoxysilane in a ratio of 10/1/2 (v/v/v). The liquor uptake was 100%. Subsequently, the so-treated polyester was exposed to a temperature of 170° C. for 60 seconds for condensation of the tetramethoxy-silane. Subsequently, the so-treated polyester was used for padding with liquor of ethanol, water, conc. hydrochloric acid and 3-aminopropyltriethoxysilane in a ratio of 10/5/1/1 (v/v/v/v). The liquor uptake was 100%. The so-treated polyester was exposed to a temperature of 170° C. for 60 seconds to condensate 3-aminopropyltriethoxysilane. The so-treated polyester was washed again at 100° C. for 5 minutes. The weight uptake of the so-treated polyester was 4%. The so-treated polyester was placed in an aqueous ammoniacal silver nitrate solution (10%) having a pH of 12 for a residence time of 30 minutes and subsequently dried at 50° C. for 15 minutes. The so-treated polyester was placed in an aqueous ascorbic acid solution (20%) and subsequently washed with water and allowed to dry.

### EXAMPLE 2

A woven fabric made of polyester was treated with aqueous sodium hydroxide solution having a concentration of 60 g/l using INVADIN LUN (prepared by the company Ciba) as wetting agent at 100° C. for 30 minutes. The liquor ratio (m (kg) substrate:V (1) solution) was 1:50. The so-treated polyester was immersed in N-(2-aminoethyl)-3-aminopropyltrimethoxysilane for 2 hours, used for padding at 3 bar and a rate of 3 m/min. Subsequently, the treated polyester was allowed to dry for 3 days. The so-treated polyester was immersed in an aqueous silver nitrate solution (10%) and ammonia solution (25%) for 1 day with stirring. The liquor ratio was 1:4. The so-treated polyester was placed in an aqueous ascorbic acid solution (10%) having a pH=11.

### EXAMPLE 3

A spacer interlaced yarn made of polyester was immersed in hexamethylene diisocyanate (20% in water) for 1 minute and subsequently in bis(3-amino-propyl)amine for 3 hours. The so-treated polyester was allowed to dry at 20° C. for 1 day. The so-treated polyester was heated in a mixture of aqueous silver nitrate solution (5%) and ammonia solution (25%) having a liquor ratio of 1:1 at 50° C. for 3 hours with stirring. The so-treated polyester was placed in an aqueous ascorbic acid solution (10%) having a pH=11. By post-treating the so-silver plated polyester with a mixture of aqueous silver nitrate solution (5%) and ammonia solution (25%), the silver plating degree could be further enhanced.

1. A method for metallizing polyester, wherein the polyester
is treated with an alkaline solution,
is treated with at least one compound having at least one functional group selected from the group consisting of a primary amine, a secondary amine, a thiol, a sulphide, and an olefin, and the compound is cross-linked,
the treated polyester is treated with a solution containing at least one metal salt selected from the group consisting of a silver salt, a copper salt, and a nickel salt, and at least one complexing agent, and
is treated with at least one reducing agent.

2. The method according to claim 1, characterized in that the alkaline solution is an aqueous or alcoholic solution containing at least one base selected from the group consisting of sodium hydroxide and potassium hydroxide, and mixtures thereof.

3. The method according to claim 1, characterized in that the at least one compound having at least one functional group selected from the group consisting of a primary amine, a secondary amine, a thiol, a sulphide, and an olefin, is a compound of the Formula
(R¹O)ₓMR₄₋ₓ (I),
wherein
R¹ is a branched or straight-chain alkyl having 1 to 20 carbon atoms, preferably having 1 to 10 carbon atoms, more preferably having 1 to 8 carbon atoms, even more preferably having 1 or 2 carbon atoms,
x is a number from 1 to 3, preferably 3,
M is Si, Ti or Sn, and
R is selected from the group consisting of CH₂CH₂CH₂NH₂, CH₂CH₂CH₂SH, CH═CH₂, (CH₂)ₚNH(CH₂)ₙNH(CH₂)ₗNH₂, and (CH₂)ₙNHₘ[(CH₂)ₗNH₂]ₖ,
p is an integer from 1 to 7, preferably 2 or 3,
n is an integer from 1 to 7, preferably 2 or 3,
m is zero, if k is 2,
m is 1, if k is 1,
and l is an integer from 1 to 7, preferably 2 or 3.

4. The method according to claim 1, wherein the at least one compound having at least one functional group selected from the group consisting of a primary amine, a secondary amine, a thiol, a sulphide, and an olefin is a compound of the Formula (I)
(R¹O)ₓMR₄₋ₓ (I),
wherein
R¹ is a branched or straight-chain alkyl having 1 to 20 carbon atoms, preferably having 1 to 10 carbon atoms, more preferably having 1 to 8 carbon atoms, even more preferably having 1 or 2 carbon atoms,
x is a number from 1 to 3, preferably 3,
M is Si, Ti or Sn, and
R is selected from the group consisting of CH₂CH₂CH₂NH₂, CH₂CH═CH₂SH, CH═CH₂, (CH₂)ₚNH(CH₂)ₙNH(CH₂)ₗNH₂, and (CH₂)ₙNHₘ[(CH₂)ₗNH₂]ₖ,
p is an integer from 1 to 7, preferably 2 or 3,
n is an integer from 1 to 7, preferably 2 or 3,
m is zero, if k is 2,
m is 1, if k is 1,
and l is an integer from 1 to 7, preferably 2 or 3, and
cross-linking is carried out by a condensation of the compound of the Formula (I).

5. The method according to claim 1, characterized in that treating with at least one compound having at least one functional group selected from the group consisting of a primary amine, a secondary amine, a thiol, and a sulphide, and cross-linking the compound comprise
contacting the polyester treated with an alkaline solution with at least one compound of the Formula (I),
(R¹O)ₓMR₄₋ₓ (I)
wherein each R and R¹ is independently from each other a branched or straight-chain alkyl having 1 to 20 carbon atoms, preferably having 1 to 10 carbon atoms, more preferably having 1 to 8, even more preferably having 1 or 2 carbon atoms, x is 1 to 4, and M is Si, Ti or Sn,
optionally a first condensation,
contacting with at least one compound of the Formula (I), wherein R¹ is a branched or straight-chain alkyl having 1 to 20 carbon atoms, preferably 1 to 10 carbon atoms, more preferably 1 to 8 carbon atoms, even more preferably having 1 or 2 carbon atoms,
x is 1 to 3, preferably 3,
M is Si, Ti or Sn,
R is selected from the group consisting of CH₂CH₂CH₂NH₂, CH₂CH₂CH₂SH, CH═CH₂, (CH₂)ₚNH(CH₂)ₙNH(CH₂)ₗNH₂, and (CH₂)ₙNHₘ[(CH₂)ₗNH₂]ₖ,
p is an integer from 1 to 7, preferably 2 or 3,
n is an integer from 1 to 7, preferably 2 or 3,
m is zero, if k is 2,
m is 1, if k is 1,
and l is an integer from 1 to 7, preferably 2 or 3, and
a second condensation.

6. The method according to claim 1, characterized in that the at least one compound having at least one functional group selected from the group consisting of a primary amine, a secondary amine, a thiol, a sulphide, and an olefin, is a compound of the Formula
R²NHR³ (II),
wherein R² is selected from the group consisting of H₂N(CH₂)_{w}, R⁴₃Si(CH₂)_{w}, and H₂NC₆H₄,
R³ is selected from the group consisting of [(CH₂)ₓNH]_{y}(CH₂)_{z}NH₂, R⁴₃Si(CH₂)_{y}, and H₂NC₆H₄NH(CH₂)_{y},
w is an integer from 1 to 7, preferably 2 or 3,
x is an integer from 1 to 7, preferably 2 or 3,
y is zero or an integer from 1 to 7, preferably zero, 1 or 2,
z is an integer from 1 to 7, preferably 2 or 3, and
R⁴ is a branched or straight-chain alkyl or —O-alkyl having 1 to 10 carbon atoms, preferably having 1 to 8 carbon atoms, more preferably having 1 or 2 carbon atoms.

7. The method according to claim 6, characterized in that the compound of the Formula (II) is selected from the group consisting of bis(3-aminopropyl)amine, N,N′-bis(2-aminoethyl)-1,3-propanediamine, triethylenetetramine, tetraethylenepentamine, bis[3-(trimethylsilyl)propyl]amine and bis[3-(trimethoxysilyl)propyl]amine.

8. The method according to claim 1, characterized in that the at least one compound having at least one functional group selected from the group consisting of a primary amine, a secondary amine, a thiol, a sulphide, and an olefin, is a compound of the Formula
R²NHR³ (II),
wherein R² is selected from the group consisting of H₂N(CH₂)_{w}, R⁴₃Si (CH₂)_{w}, and H₂NC₆H₄,
R³ is selected from the group consisting of [(CH₂)ₓNH]_{y}(CH₂)_{z}NH₂, R⁴₃Si(CH₂)_{y}, and H₂NC₆H₄NH(CH₂)_{y},
w is an integer from 1 to 7, preferably 2 or 3,
x is an integer from 1 to 7, preferably 2 or 3,
v is zero or an integer from 1 to 7, preferably zero, 1 or 2,
z is an integer from 1 to 7, preferably 2 or 3, and
R⁴ is a branched or straight-chain alkyl or —O-alkyl having 1 to 10 carbon atoms, preferably having 1 to 8 carbon atoms, more preferably having 1 or 2 carbon atoms, and
cross-linking is carried out by addition of a compound having at least one isocynanate group, preferably two isocynanate groups.

9. The method according to claim 8, characterized in that the compound having at least one isocynanate group is selected from the group consisting of hexamethylene diisocyanate, tolylene diisocyanate, isophorone diisocyanate, and 4,4′-methylene-bis(cyclohexyl isocyanate).

10. The method according to claim 1, characterized in that the complexing agent is selected from the group consisting of ammonia, ethylenediamine, triethanolamine, ethanolamine, 1,3-diaminopropane, sodium thiosulphate, thioisocyanate, glycerol, sodium tartrate, potassium sodium tartrate, and sodium citrate.

11. The method according to claim 1, characterized in that the metal salt is selected from the group consisting of silver halide, silver sulphate, silver nitrate, copper halide, copper sulphate, copper nitrate, copper acetate, nickel halide, nickel sulphate, nickel nitrate, and nickel acetate, that the metal salt is preferably silver nitrate, silver chloride or silver sulphate.

12. The method according to claim 1, characterized in that the reducing agent is selected from the group consisting of glucose, ascorbic acid, sodium borohydride, sodium dithionite, sodium sulphite, sodium formate, formaldehyde, and sodium hydrophosphite.

13. The method according to claim 1, characterized in that the polyester is selected from the group consisting of poly(ethylene terephthalate), poly(butylene terephthalate), and mixtures thereof.

14. The method according to claim 1, characterized in that subsequent to the step of the treatment with a reducing agent, the polyester is treated with an agent selected from the group consisting of reducing agent, complexing agent, and polymer.

15. (canceled)

16. (canceled)

17. A coated polyester containing a polyester comprising a layer of a cross-linked product obtained by a condensation or addition reaction of at least one compound having at least one functional group selected from the group consisting of a primary amine, a secondary amine, a thiol, a sulphide, and an olefin, and a layer of metal selected from the group consisting of silver, copper, and nickel.

18. The coated polyester according to claim 17, characterized in that the cross-linked product comprises a polysilicic acid having at least one functional group selected from the group consisting of a primary amine, a secondary amine, a thiol, a sulphide, and an olefin, preferably a condensation-product of at least one compound of the Formula (I)
(R¹O)ₓMR₄₋ₓ (I),
wherein R¹ is a branched or straight-chain alkyl having 1 to 20 carbon atoms, preferably 1 to 10 carbon atoms, more preferably 1 to 8 carbon atoms, even more preferably having 1 or 2 carbon atoms,
x is a number from 1 to 3, preferably 3,
M is Si,
R is selected from the group consisting of CH₂CH₂CH₂NH₂, CH₂CH₂CH₂SH, CH═CH₂, (CH₂)ₚNH(CH₂)ₙNH(CH₂)_{I}NH₂, and (CH₂)ₙNHₘ[(CH₂)ₗNH₂]ₖ,
p is an integer from 1 to 7, preferably 2 or 3,
n is an integer from 1 to 7, preferably 2 or 3,
m is zero, if k is 2,
m is 1, if k is 1,
and l is an integer from 1 to 7, preferably 2 or 3, and
the layer of a metal is a layer of silver.

19. The coated polyester according to claim 17, characterized in that the cross-linked product comprises an urea comprising preferably an addition product of at least one compound of the Formula
R²NHR³ (II),
wherein R² is selected from the group consisting of H₂N(CH₂)_{w}, R⁴₃Si(CH₂)_{w}, and H₂NC₆H₄,
R³ is selected from the group consisting of [(CH₂)ₓNH]_{y}(CH₂)_{z}NH₂, R⁴₃Si(CH₂)_{y}, and H₂NC₆H₄NH(CH₂)_{y},
w is an integer from 1 to 7, preferably 2 or 3,
x is an integer from 1 to 7, preferably 2 or 3,
y is zero or an integer from 1 to 7, preferably zero, 1 or 2,
z is an integer from 1 to 7, preferably 2 or 3, and
R⁴ is a branched or straight-chain alkyl or —O-alkyl having 1 to 10 carbon atoms, preferably having 1 to 8 carbon atoms, more preferably having 1 or 2 carbon atoms, and
a compound selected from the group consisting of hexamethylene diisocyanate, tolylene diisocyanate, isophorone diisocyanate, and 4,4′-methylene-bis(cyclohexyl isocyanate).

20. A use of a polyester according to claim 17 for antimicrobially treating liquid in liquid-guiding systems or for producing socks, insoles, clothing, covering textiles for seating furniture or mattresses.
